(19) United States
(12) Patent Application Publication
(10) Pub. No.: US 2021/0071596 A1
(43) Pub. Date: Mar. 11, 2021

(54) Engine Control System and Method

(71) Applicant: Caterpillar Inc., Peoria, IL (US)

(72) Inventors: Nathan Atterberry, Washington, IL (US); Matthew Parker, Washington, IL (US); Matthew Engfehr, Dunlap, IL (US)

(73) Assignee: Caterpillar Inc., Peoria, IL (US)

(21) Appl. No.: 16/566,357

(22) Filed: Sep. 10, 2019

(51) Int. Cl. F02D 19/06

(52) U.S. Cl. CPC F02D 19/0607; F02D 19/0626; F02D 19/0613

(57) ABSTRACT

A fuel control system can operate an internal combustion engine to selectively combust a first fuel, such as diesel, during a single fuel mode and to combust the first fuel and a second fuel, such natural gas, during a fuel substitution mode. An in-cylinder parameter sensor is in communication with the combustion chamber of the internal combustion engine to measure an in-cylinder parameter such as, for example, the indicated mean effective pressure, during combustion of the first fuel during the single fuel mode. The fuel control system utilizes the in-cylinder parameter to determine a first fuel quantity error and can adjust delivery of the first fuel to correct for the first fuel quantity error during the single fuel and fuel substitution modes. The fuel control system can also use the first fuel quantity error to determine and adjust for a second fuel quantity error.

### TECHNICAL FIELD

This patent disclosure relates generally to an internal combustion engine configured for combusting different fuels and, more particularly, to a system and method for controlling operation of the duel fuel system for an internal combustion engine.

### BACKGROUND

Internal combustion engines receive and combust a mixture of a hydrocarbon-based fuel and air to convert the chemical energy associated with the fuel to a mechanical force that can be applied for useful work. Combustion of fuel typically occurs in a combustion chamber, which may include a cylinder having a reciprocating piston movably disposed therein. To provide fuel for combustion, the internal combustion engine may be operatively associated with a fuel delivery system that can pressurize and direct fuel to the combustion chamber where the fuel is ignited and expands to forcibly drive the piston linearly within the cylinder. The piston in turn may be connected to and rotate a crankshaft resulting in torque or mechanical force. The motive force produced by the internal combustion engine may be utilized for any useful purpose such as to power a mobile machine like a dozer or wheel loader, to rotate a generator to generate electrical power, or for other industrial purposes such as driving pumps or fans.

In some embodiments, the internal combustion engine may be configured to combust different types of fuel in what is referred to as a dual fuel system. It may be desirable to burn different fuels or different mixtures of fuels at different times for energy efficiency or economic reasons or because certain fuels may combust more cleanly to reduce emissions. For example, the internal combustion engine may be configured to combust a liquid fuel such as diesel at certain times then combust a mixture of the liquid fuel and a natural gas such as methane or propane. Natural gas may be less expensive than diesel and may burn cleaner. However, natural gas may be associated with combustion stability issues, may have indeterminate or varying heat values that are associated with energy release, and may require an external source of ignition. Accordingly, in some embodiments of a dual fuel system, a small quantity of diesel fuel may be selectively introduced as a pilot fuel to the combustion chamber in which natural gas and air was previously introduced. Timed introduction of the diesel fuel may spontaneously auto ignite under compression from motion of the piston which in turn ignites the natural gas. U.S. Patent Publication No. 2019/0186391 (“the '391 publication”) describes an internal combustion engine configured to selectively switch between combusting diesel fuel only and a mixture of natural gas and diesel. The '391 publication also describes a control system for switching between the different fuels by monitoring cylinder pressure data. The present application is directed to related but different technology as disclosed in the '391 publication.

### SUMMARY

The disclosure describes, in one aspect, internal combustion engine including a combustion chamber with a cylinder and a piston reciprocally disposed therein. The internal combustion engine can include a first fuel delivery system to deliver a first fuel to the cylinder and a second fuel delivery system to deliver a second fuel to the cylinder. An in-cylinder parameter sensor may be in communication with the combustion chamber to measure an in-cylinder parameter. The internal combustion engine is also associated with an electronic controller in electronic communication with the first fuel delivery system, the second fuel delivery system, and the in-cylinder pressure sensor. The electronic controller is configured to retrieve and apply a first fueling command directing the first fuel system to deliver an initial quantity of the first fuel to the combustion chamber. The electronic controller can receive electronic signals from the in-cylinder parameter sensor indicative of the in-cylinder parameter as measured during combustion of only the first fuel in the combustion chamber. The electronic controller coverts the in-cylinder parameter to a first fuel power output indicative of power output from combustion of the initial quantity of the first fuel and determines a first fuel quantity error based on the first fuel power output. The electronic controller can use the first fuel quantity error to adjust for delivery of the first fuel during fuel substitution mode when first and second fuels are delivered and combusted in the combustions chamber.

The disclosure describes, in another aspect, a method of operating an internal combustion engine. According to the method, a first fueling command directs that an initial quantity of a first fuel is delivered to a combustion chamber of an internal combustion chamber during a single fuel mode. The first fuel is combusted in the combustion chamber and an in-cylinder parameter is measured indicative of the in-cylinder condition during combustion of the first fuel only. The in-cylinder parameter is converted to a first fuel power output indicative of the power output from combustion of the first fuel. The first fuel power output is used to determine a first fuel quantity error. The method thereafter uses the first fuel quantity error to adjust a substitution fueling directing a substitution quantity of the first fuel and the second fuel to be delivered to the combustion chamber during a fuel substitution mode.

In yet another aspect, the disclosure describes a fuel control system for controlling operation of an internal combustion engine. The fuel control system uses an in-cylinder parameter sensor in communication with a combustion chamber of the internal combustion engine to measure an in-cylinder parameter. An electronic controller of the fuel control system is in communication with the in-cylinder parameter sensor and with a first fuel delivery system and a second fuel delivery system to deliver first fuel and a second fuel respectively to the combustion chamber. The electronic controller can retrieve and apply a first fueling command directing the first fuel system to deliver an initial quantity of the first fuel to the combustion chamber and can receive electronic signals from the in-parameter sensor indicative of the in-cylinder parameter as measured during combustion of the first fuel. The electronic controller can convert the in-cylinder parameter to a first fuel power output and determine a first fuel quantity error based on the fuel power output. The electronic controller thereafter adjusts the first fueling command based on the first fuel quantity error.

### BRIEF DESCRIPTION OF THE DRAWINGS

FIG. 1 is a perspective view of an embodiment of an internal combustion engine having a plurality of combustion chambers for combusting and converting a hydrocarbon-based fuel and an oxidizer to produce a mechanical force.

FIG. 2 is a partial sectional view of a combustion chamber of the internal combustion engine of FIG. 1 and associated devices and systems that are configured for selectively combusting different fuels.

FIG. 3 is a schematic block diagram of a fuel control system including an electronic controller and associated devices and systems for operating the internal combustion engine using different fuels.

FIG. 4 is a flowchart depicting a computer executable process, routine, or algorithm that the fuel control system may execute for regulating operation of the internal combustion engine using different fuels.

FIG. 5 is a schematic representation of a chart illustrating fuel quantity adjustments that may be made in accordance with the disclosure.

FIG. 6 is a flowchart depicting a computer executable process, routine, or algorithm that the fuel control system may execute to adjust for errors regarding a second fuel such as natural gas.

### DETAILED DESCRIPTION

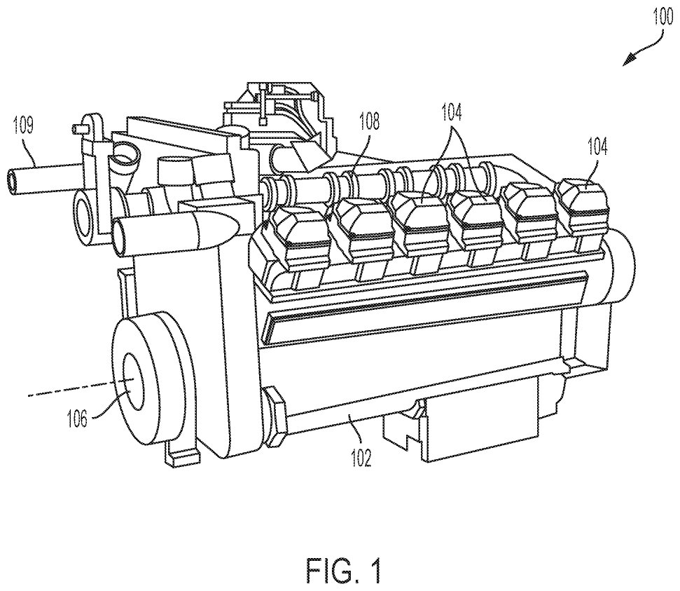

Now referring to the drawings, wherein like reference numbers refer to like elements, there is illustrated a representative embodiment of an internal combustion engine 100 for combusting hydrocarbon-based fuels to convert the latent chemical energy therein to a motive mechanical force. The internal combustion engine 100 can be intended for any suitable application such as to propel a mobile machine, to rotate a generator for generating electricity, or for some other industrial application. The internal combustion engine 100 may include an engine block 102 that may be formed by cast and/or machined metal, such as iron, steel, aluminum, or alloys thereof. Disposed in the engine block 102 may be a plurality of combustion chambers 104 in which the combustion of fuel and an oxidizer such as air occurs. Combustion of fuel and air in the combustion chambers 104 can forcibly drive another component such as a crankshaft 106 that is rotatably supported by the engine block 102. Rotating of the crankshaft 106 provides a mechanical force that can be harnessed for other work. The engine 100 may accommodate any suitable number of combustion chambers 104 and the combustion chambers may be arranged in a V-configuration, an in-line configuration, a radial configuration, or any other suitable configuration. To direct air or another oxidizer to the combustion chambers 104, the engine 100 may be operatively associated with an air intake manifold 108 communicating with each of the combustion chambers 104 and to remove the resulting exhaust gasses produced by the combustion process, the engine 100 may be operatively associated with an exhaust manifold 109 also communicating with each of the combustion chambers. In addition to the internal combustion engine 100 illustrated in FIG. 1, aspects of the disclosure may be applicable to other types of engines and combustion machines such as gas turbines, steam boilers, or the like.

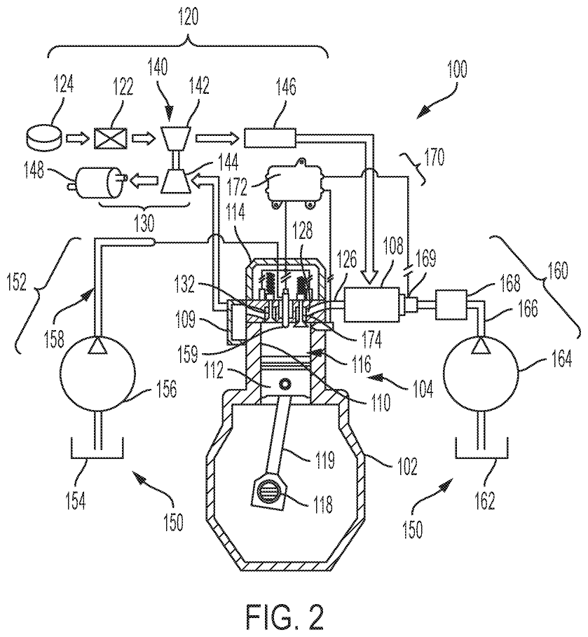

Referring to FIG. 2, there is illustrated an embodiment of the combustion chamber 104 that may be included with the internal combustion engine 100. The combustion chamber 104 illustrated in FIG. 2 may be representative of other combustion chambers included with the internal combustion engine 100 and the following description of its components and operating principles may be common to all chambers included with the engine. The combustion chamber 104 includes a bore or cylinder 110 that may be disposed into the engine block 102 and that can accommodate a movable piston 112. The cylinder 110 and piston 112 may both be circular in cross-section and can be dimensioned to form a sliding fit with each other. The upper end of the cylinder 110 is enclosed by a cylinder head 114 that may be bolted or mounted to the engine block 102. The piston 112 is reciprocally moveable in the cylinder 110 between an top dead center position (TDC) in which the piston is closest to the cylinder head 114 and a bottom dead center position (BDC) in which the piston is furthest from the cylinder head. These motions accomplish an intake-compression stroke and an expansion-exhaust stroke as will be familiar to those of skill in the art. The combustion chamber 104 thereby defines a variable volume 116 that expands and contracts as the as the piston 112 reciprocates in the cylinder 110 between TDC, where the variable volume is at its smallest, and BDC, where the variable volume is at its largest. The compression ratio of the internal combustion engine 100 is calculated based on the relative volumes of the variable volume 116 between BDC and TDC, and for typical auto ignition diesel engines may be on the order of 15:1. The piston 112 can be operatively connected to the rotatable crankshaft 106 by a connecting rod 119 in the conventional manner. Linear motion of the piston 112 in the cylinder 110 therefore results in rotatable motion of the crankshaft 106.

To provide an oxidizer for combustion of fuel, the internal combustion engine 100 can be operatively associated with an air intake system 120 that directs atmospheric air to the plurality of combustion chambers 104. The air intake system 120 can include an air inlet 122 that may be an adjustable governor or intake throttle to control and regulate the amount of air drawn into the internal combustion engine 100. To remove particles, dirt, and moisture from the intake air, the air inlet 122 may be operatively associated with an upstream air filter 124. The air inlet 122 may communicated with and direct intake air to the air intake manifold 108 that extends across and may be common to each of the plurality of combustion chambers 104 included with the internal combustion engine 100. To establish fluid communication between the intake manifold 108 and the individual cylinders 110, a plurality of intake runners 126 may extend from the intake manifold and may pass through the cylinder head 114 such that at least one intake runner is associated with each of the plurality of combustion chambers 104. To selectively introduce intake air from the intake manifold 108 to the cylinders 110, each combustion chamber 104 is operatively associated with an intake valve 128 disposed in the cylinder head 114 and arranged to open and close the intake runner 126. The intake valve 128 may be a mechanical or electromechanical device such as a poppet valve that can bear against or lift from a seat or port disposed in the cylinder head 114 to selectively permit access into the cylinder 110.

To remove the byproducts of the combustion process, including exhaust gasses and particulate matter, from the combustion chambers 104, the internal combustion engine 100 can be operatively associated with an exhaust system 130. In particular, one or more exhaust valves 132 that may be similar in construction and operation to the intake valves 128 may be disposed in the cylinder head 114 to provide selective communication between the cylinder 110 and the exhaust manifold 109. Accordingly, upward motion of the piston 112 discharges exhaust gasses to the exhaust manifold 109 when the exhaust valves 132 are opened. The exhaust manifold 109 may also be common to the plurality of combustion chambers 104 included with the internal combustion engine 100. In an embodiment, to assist in directing intake air to and exhaust gasses from the combustion chambers 104, the internal combustion engine 100 can be operatively associated with a turbocharger 140. The turbocharger 140 includes a compressor 142 in fluid communication with and downstream of the air inlet 122 that compresses intake air and directs the intake air to the intake manifold 108. To drive the compressor 142, the turbocharger 140 can include a turbine 144 in fluid communication with the exhaust manifold 109 that receives pressurized exhaust gases discharged by the combustion chamber 104. The pressurized exhaust gasses directed through the turbine 144 can rotate a series of blades therein that are rotatably coupled to a series of blades in the compressor 142. Forced rotation of the compressor 142 pressurizes intake air directed to the combustion chambers 104 thereby increasing the efficiency and power output of the internal combustion engine 100. In an embodiment, to lower the temperature of the compressed intake air, an aftercooler 146 may be disposed downstream of the compressor 142. To reduce emissions and/or noises associated with exhaust gases, an aftertreatment system 148 such as a catalyst or muffler may be disposed downstream of the turbine 144. The internal combustion engine 100 may be operatively associated with other features and systems to improve performance such as, for example, an exhaust gas recirculation (EGR) system to reduce emissions.

To provide different fuels for combustion in accordance with the disclosure, the internal combustion engine 100 is operatively associated with a dual fuel system 150. For example, the first fuel may be a liquid fuel such as diesel that is capable of spontaneous auto-ignition and the second fuel may be a gaseous fuel such as natural gas that may be less expensive and may combust more cleanly than liquid fuels. To supply the first fuel in a liquid state to the combustion chambers 104, the dual fuel system 150 includes a first fuel delivery system 152. The first fuel may be contained in a first fuel tank 154 or reservoir that is adapted to hold liquids. The first fuel tank 154 may be in fluid communication with a first fuel pump 156 that pressurizes the first fuel and directs it through first fuel lines 158, which may be hoses or channels, to the plurality of combustion chambers 104. To selectively introduce the first fuel into the combustion chambers 104, the first fuel delivery system 152 includes a first fuel admission valve 159 disposed through the cylinder head 114 and in communication with the cylinder 110. The first fuel admission valve 159 may be a liquid fuel injector partially disposed in the cylinder 110 through the cylinder head 114. The liquid fuel injector can be an electromechanical device such as a solenoid operated valve that selectively injects fuel into the cylinder 110 and that can precisely control the timing, duration, and quantity of the first fuel introduced to the cylinder 110. The liquid fuel injector can be configured to vaporize and disperse the liquid first fuel entering the cylinder 110 to improve combustion. In other embodiments, the first fuel may be introduced upstream of the cylinder 110 or may be introduced through port injection methods. In an embodiment, the first fuel delivery system 152 can be associated with a fuel rail that is configured to return pressurized liquid fuel that has not been injected to the combustion chambers 104 to the first fuel tank 154.

To supply the second fuel in a gaseous state to the combustion chambers 104, the dual fuel system 150 includes a second fuel delivery system 160. To store the second fuel, the second fuel delivery system 160 may include a second fuel tank 162 or reservoir that is adapted for holding gaseous fuels. In an embodiment, the second fuel tank 162 may be configured to hold the second fuel in a highly pressurized or cryogenic state. Accordingly, in a possible embodiment, the second fuel may initially be stored in a partial or complete liquid state in the second fuel tank 162. To direct the second fuel to the combustion chambers 104, the second fuel tank 162 can be in fluid communication with a second fuel pump 164 via a second fuel line 166 that can be a hose or a channel. In the embodiments in which the second fuel is initially in a partial or complete liquid phase, vaporization and pressurization equipment 168 may be disposed in the second fuel line 166 to convert the second fuel to a gaseous state. In an embodiment, the second fuel pump 164 may direct the second fuel to the intake manifold 108 via the second fuel line 166 that can be a hose or channel. To selectively introduce the second fuel to the intake manifold 108, a second fuel admission valve 169 can be mounted on the intake manifold and fluidly connected with the second fuel line 166. The second fuel therefore mixes with the intake air upstream of the cylinder 110. The second fuel admission valve 169 can be a gas admission valve and in an embodiment may be in the form of a gate valve, butterfly valve, ball valve, or the like having a disk or ball that moves or rotates with respect to an orifice or tubular valve body. The gas admission valve can control the timing, duration, and quantity of the second fuel introduced to the cylinder 110. In other embodiments, the second fuel delivery system 160 may introduce the second fuel directly to the intake runners 126 downstream of the intake manifold 108, directly to the cylinder 110, or at another suitable location.

To regulate and control operation of the dual fuel system 150, the internal combustion engine 100 can be operatively associated with an electronic fuel control system 170, which may be part of an engine control system, engine control unit, or engine control module. The electronic fuel control system 170 can include an electronic controller 172 that can be in electronic communication with the first fuel admission valve 159 and with the second fuel admission valve 169 to operatively control activation of those devices and the selective introduction of fuel to the combustion chamber 104. The electronic controller 172 can have any suitable computer architecture and can receive, process, and send electronic signals in digital or analog form to operatively control the first and second fuel admissions valves 159, 169. In addition, the electronic controller 172 can execute and process functions, steps, routines, algorithms, applications, control maps, data tables, and the like utilizing computer executable software instructions and code that may be stored in and retrievable from computer readable and writable memory or other electronically accessible data storage. The electronic controller can be configured as a microprocessor, an application specific integrated circuit (ASIC), a field programmable gate array (FPGA), or can have other appropriate circuitry structure to execute computer programs and applications to perform operations or tasks. The electronic controller 172 may be associated with memory or other data storage capabilities. The memory can include any suitable type of electronic memory devices such as random access memory (“RAM”), read only memory (“ROM”), dynamic random access memory (“DRAM”), flash memory, magnetic memory such as hard drives, laser readable optical memory, and the like. Although in the schematic representation of FIG. 1, the electronic controller 172 is represented as a single, discrete unit, in other embodiments, the electronic controller 172 and its functions may be distributed among a plurality of distinct and separate components.

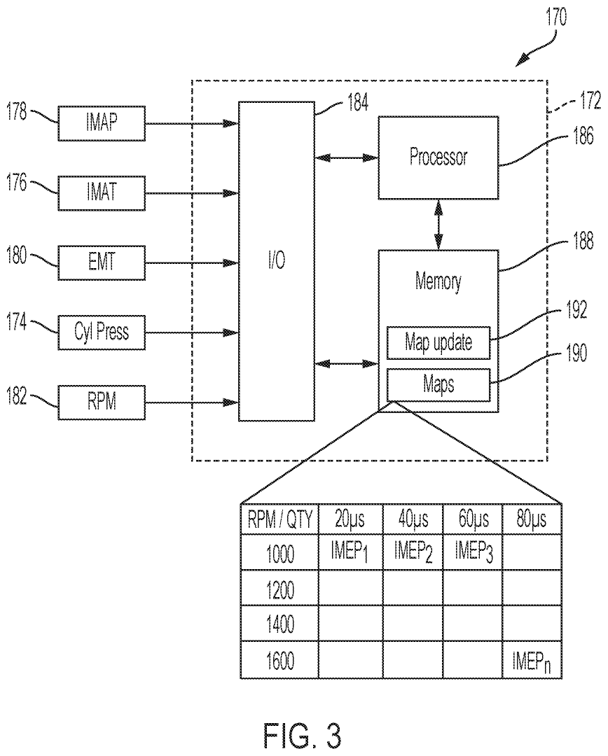

Referring to FIG. 3, there is illustrated a schematic block diagram of the fuel control system 170 including the electronic controller 172 for regulating and controlling the dual fuel system 150. The fuel control system 170 receives data and information about the operational characteristics of the internal combustion engine and utilizes that information to regulate and adjust various modes of operation with respect to the first fuel and the second fuel. For example, operation using the second fuel, such as natural gas, may be desirable for economic or emissions reasons; however, the second fuel may be associated with combustion stability issues related to when the second fuel can ignite and combust. As a particular example, the auto ignition temperature of the second fuel such as natural gas may not be well defined and may vary among different sources or formulations of the second fuel. Relatedly, at cold start when the engine has not been previously running, the second fuel may fail to ignite in a timely manner. Moreover, the heating value of the second fuel, which relates to the energy released during combustion, may be less well defined. Accordingly, the first fuel may be substituted or combined with the second fuel to result in more consistent and predictable operation of the internal combustion engine. In particular, the dual fuel system 150 can operate in both a single fuel mode in which the liquid first fuel, e.g., diesel, is combusted and in a fuel substitution mode in which the gaseous second fuel, e.g., natural gas, is combined with the liquid first fuel for combustion. The process of switching between different fuel modes and combining different fuels may be referred to as fuel substitution.

To receive data and information about the operation of the internal combustion engine, the fuel control system 170 may be operatively associated with a plurality of sensors including, for example, an in-cylinder parameter sensor 174. The in-cylinder parameter sensor 174 can be configured to sense or measure inputs, or an in-cylinder parameter, that is directly or indirectly indicative of the power output of the internal combustion engine. In an embodiment, the in-cylinder parameter sensor 174 may be an in-cylinder pressure sensor that communicates with or is exposed to the cylinder 110, as illustrated in FIG. 2, and that measures the fluid pressure in the cylinder. As the piston 112 moves between the BDC position and the TDC position, and as fluids including air and fuel are introduced, the cylinder pressure varies in accordance with the intake, compression, expansion, and exhaust strokes of the engine cycle. The cylinder pressure can be indicative of and converted to the torque applied to the crankshaft 106, which can be indicative of and converted to the power output generated by the internal combustion engine 100. Accordingly, by monitoring cylinder pressure over the course of at least a portion of an engine cycle, such as 180 crank angle degrees, 360 crank angle degrees, or 720 crank angle degrees for a full four-stroke engine cycle, can provide an indication of engine power output. The in-cylinder pressure sensor can utilize any suitable pressure sensing technology and construction such as piezoelectric effects, capacitive changes, electromagnetic effects, strain gauges, and the like. The in-cylinder pressure senor may be a dynamic sensor configured to measure both the instantaneous cylinder pressure and the change in cylinder pressure during the engine cycle.

In an embodiment, the fuel control system 170 and in-cylinder parameter sensor 174 in the form of a dynamic pressure sensor may be configured to determine an in-cylinder parameter referred to as the indicated mean effective pressure (IMEP). IMEP represents the amount of torque generated in the combustion chamber during the engine cycle and is useful in measuring engine power output. The IMEP may be considered as the average pressure acting on the piston during the course of the engine cycle, which can be converted to torque in the crankshaft, and thus the combustion chamber power output in terms of unit time. IMEP may be expressed in any suitable terms such as kilopascals (kPa) or megapascals (mPa). IMEP may be calculated according to the following exemplary equation:

IMEP=∫P_{cyl}*dV_{cyl} Eqn. 1:

which is integrated over engine cycle from 0° crank angle to 720° crank angle and wherein Pcyl is the cylinder pressure and dVcyl is the derivative of the volume over time:

V_{cyl}=V_{cyl@TDC}(1+0.5(r_{c}−1)(R+1−cos θ−(R²−sin²θ)^{0.5}) Eqn. 2:

The fuel control system 170 can be associated with other sensors and controls to assist in operation of the dual fuel system 150. For example, referring to FIG. 3, to determine the temperature of the intake air, which can affect the power output of the engine, an intake manifold temperature sensor 176 such as a transducer or other electronic device can be disposed in or associated with the intake manifold of the internal combustion engine. Similarly, an intake manifold pressure sensor 178 indicative of the pressure in the intake manifold, that may relate to the quantity of intake air introduced to the cylinder, can also be disposed in or associated with the intake manifold of the engine. An exhaust manifold temperature sensor 180 can be disposed in or associated with the exhaust manifold to measure the exhaust temperature, which can be indicative of the heat released by the combustion process and that can be related to the power output of the internal combustion engine. An engine speed sensor 182 can be included to measure the speed of the engine from the perspective of the crankshaft in terms of revolutions per minute (RPM). The engine speed and the in-cylinder pressure from the in-cylinder parameter sensor 174 can be converted to the power output of the internal combustion engine according to known equations and can be expressed in terms like horsepower or watts.

To send and receive signals with the plurality of sensors, the electronic controller 172 can include or be associated with an input/output, or I/O interface 184. The I/O interface 184 can utilize digital or analog electronic signals for communication and may direct the signals over any suitable communication channels including conductive wires, buses, optical fibers, or wirelessly such as by radiofrequency (RF) signal. In an embodiment, I/O interface 184 and communication channels can be configured as a controller area network (CAN). As indicated above, the electronic controller 172 can also include one or more processors 186 which includes the integrated circuitry to execute instructions encoded in software, perform operations on and processing of the data received from the plurality of sensors, and to output directions to control and regulate operation of the internal combustion engine. The processor 186 can be operatively associated with machine readable memory 188, such as RAM, ROM, or magnetic memory, in which the software instructions are stored and data can be written to and read from. In particular, the memory 188 may store software related to one or more engine fueling charts, tables, or maps 190 and a fueling map update routine, module, or algorithm 192. Fueling maps are typically machine readable data relations representing correlations and relations between fuel quantities and engine output, may include a plurality of variables effecting engine operation, and may be depicted as a graph, chart, table, or map. One example of a fueling map 190 is illustrated in FIG. 3, which relates or correlates operational parameters such as fuel quantity or duration introduced to a combustion chamber, engine speed, and IMEP. In the illustrated example, fuel quantity and engine speed may be represented on the axes and the IMEP may be represented as data points. However, the fueling maps may have arrangements or configurations other than as indicated in FIG. 3, may include additional or different data, and may depict other relations between information and data. The data for populating the fueling maps may be stored in and accessible from a database or other data array.

In an aspect of the disclosure, the fuel control system 170 can receive signals indicative of engine power output generated by the combustion of fuel and can use that information to regulate and control the dual fuel system 150. For example, the fuel control system 170 and the in-cylinder parameter sensor 174 can operate to determine the engine power output with respect to an individual combustion chamber when the dual fuel system 150 delivers and combusts only the liquid first fuel such as diesel, in a single fuel mode. The engine power output by combusting the first fuel only can be determined based upon the IMEP, although in other embodiments, the fuel control system 170 may utilize other in-cylinder parameters such as peak pressure, heat release, burn duration, or other parameters. The other in-cylinder parameters can be measured utilizing the sensors or combination of sensors illustrated in FIG. 3. The fuel control system 170 can process and analyze the in-cylinder parameter to identify and resolve fueling errors occurring with the first fuel delivery system 152. Moreover, the fuel control system 170 can use the in-cylinder parameter to identify and resolve fueling errors that may be occurring with the second fuel delivery system 160 during the fuel substitution mode. Using in-cylinder parameters measured with respect to combustion of the first fuel to determine fueling errors associated with the second fuel may be advantageous because the combustion stability and or heating value of the second fuel, natural gas for example, may be less determinate or consistent than the first fuel, diesel for example. Flow control in the second fuel admission valve 169, a gate valve or butterfly valve for example, may also be less accurate than with the first fuel admission valve 159, which may be an injector, especially if the second fuel is a compressible gas like natural gas and the first fuel is an incompressible liquid like diesel that can be more reliably metered. Boundary conditions such as intake manifold air temperature, air/fuel ratio, engine load, and others may also affect combustion of the gaseous second fuel. The fuel control system 170 can utilize the in-cylinder parameters and information so that operation during and between the single fuel mode and/or fuel substitution mode is indistinguishable and transition between the modes is transparent.

### INDUSTRIAL APPLICABILITY

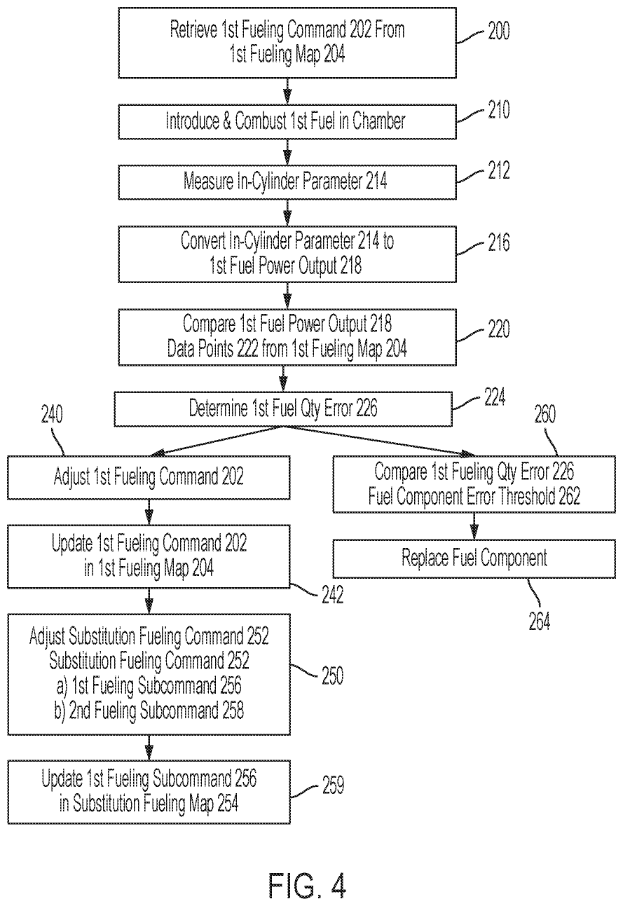

Referring to FIG. 4, there is illustrated a flowchart, representing an embodiment of a possible program, function, application, process, routine, or algorithm for conducting a fuel control system 170 for a dual fuel system 150 and which may be executed by the electronic controller 172 of FIG. 2. In a command retrieval step 200, the fuel control system 170 can receive a first fueling command 202 from a first fueling map 204 that directs an initial quantity of the first fuel such as diesel to a combustion chamber 104 during a single fuel mode, such as during cold start of the internal combustion engine. In an example, the first fueling command 202 may be expressed quantitatively in a volumetric amount of first fuel to be delivered to the cylinder 110, such as in cubic millimeters (mm³). In another example, the first fueling command 202 may be expressed as temporal duration, such as in microseconds (μs), during which the first fuel admission valve 159 actively delivers fuel to the cylinder 110, which may correspond to a determined quantity of the first fuel. It can be appreciated that if the first fuel is an incompressible liquid like diesel, the timing, flowrate, and quantity of fuel delivered by the first fuel admission valve 159 can be precisely controlled. The first fueling map 204 and the first fueling command 202 retrieved therefrom can be based on predetermined parameters and variables, for example, based upon an as-manufactured condition of the internal combustion engine 100. In an embodiment, the first fueling command 202 may introduce the first fuel through a plurality of first fuel shots to better disperse the fuel in the cylinder 110. The data in the first fueling map 204 may be determined theoretically, established empirically in advance, or otherwise.

In a combustion step 210, the first fuel in the quantity directed by the first fueling command 202 is introduced and combusted in the combustion chamber 104. Combustion of the first fuel and resulting volumetric expansion of gases in the cylinder 110 forces the piston 112 to the BDC position resulting in torque applied to the crankshaft 106. In a measurement step 212, the fuel control system 170 can measure an in-cylinder parameter 214 regarding thermodynamic conditions in the cylinder 110 during the engine cycle operating in single fuel mode. In an embodiment, the in-cylinder parameter 214 may be the IMEP during the engine cycle that may be measured by an in-cylinder parameter sensor 174. In other embodiments, other parameters can be measured that are indicative of the in-cylinder conditions such as peak cylinder pressure, heat release, burn duration, or the like. In embodiments, the parameters can be assessed with other information about the engine, such as displacement or volume, to estimate the power being output by the combustion cycle. In a conversion step 216, the fuel control system 170 converts the in-cylinder parameter 214 to a first fuel power output 218, which is the power output of the individual combustion chamber 104 due to combustion of the first fuel during single fuel mode.

The fuel control system 170 can compare the first fuel power output 218 to a known or predetermined value to assess any errors or discrepancy with the dual fuel system 150. For example, in a power comparison step 220, the fuel control system 170 can compare the first fuel power output 218 with data points 222 from the first fueling map 204 that may represent a desired or anticipated power output associated with the first fueling command 202. The measured valve of the first fuel power output 218 and the anticipated data points 222 from the first fueling map 204 may be different because of deterioration, wear, or damage with first fuel admission valve 159 or other components of the first fuel delivery system 152. For example, fuel filters may clog, seals may leak, and springs may fail. As a result of the power comparison step 220, the fuel control system 170 in a subsequent error determination step 224 can determine a first fuel quantity error 226. The first fuel quantity error 226 represents the difference between a desired or anticipated quantity of the first fuel to be delivered in accordance with the first fueling command 202 and the actual amount of the first fuel delivered.

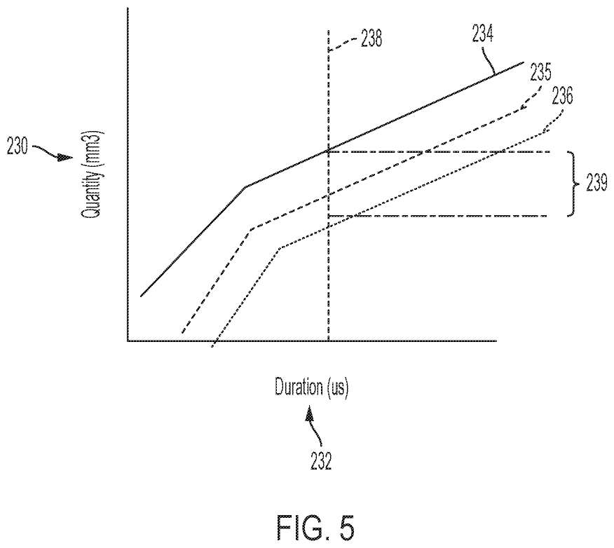

The fuel control system 170 can adjust regulation or operation of the first fuel delivery system 152 based on the first fuel quantity error 226. Referring to FIG. 5, for example, there is illustrated a chart depicting different correlations of fuel quantities 230 on the y-axis with the duration 232 that the first fuel admission valve 159 is active on the x-axis. By way of example, fuel quantity may be measured in cubic millimeters (mm³) and duration may be measured in microseconds (μs). A plurality of fuel delivery plots, including a first plot 234, a second plot 235, and a third plot 236, are illustrated for different operational conditions of the first fuel admission valve 159. As indicated by the vertical line 238, the first fuel admission valve 159 may deliver different amounts of fuel for the same commanded duration. In particular, the bracket 239 indicates that for the same duration of fuel injection, less fuel is delivered to the cylinder. This may be due to valve deterioration over time, for example, from an as-manufactured condition to a point of failure. Accordingly, in an adjustment step 240, the fuel control system 170 may adjust the first fueling command 202, for example, by increasing the duration the first fuel admission valve 159 remains active to deliver the desired quantity of the first fuel. The fuel control system 170 in an updating step 242 may also update the first fueling map 204 to adjust for the first fuel quantity error 226. Updating may be accomplished by overwriting previous values of the first fueling command in an electronic database or similar electronically accessible data array.

In another aspect, the fuel control system 170 can utilize the first fuel quantity error 226 to adjust the dual fuel system 150 for improved operation during the fuel substitution mode. During fuel substitution mode, the fuel control system 170 can retrieve a substitution fueling command 252 from a fuel substitution map 254, which may represent the relative quantities of the first fuel and the second fuel to introduce to the combustion chamber 104 for combustion. By way of example, in fuel substitution mode, the fuel control system 170 may direct that the dual fuel system 150 operate on 20 percent of the first fuel, e.g., diesel, and 80 percent of the second fuel, e.g., natural gas. In another example, the dual fuel system 150 can direct that the dual fuel system operate on 50 percent of the first fuel and 50 percent of the second fuel. In fuel substitution mode, the first fuel whether it be diesel or another liquid fuel can serve to spontaneously auto ignite in the combustion chamber due to compression, and serves to thereby ignite the second fuel therein. The timing of the introduction of the first fuel to the combustion chamber serves to control the timing of the ignition of the second fuel. The fuel substitution map 254 can reflect the ratios of the first and second fuels to be delivered during fuel substitution mode, or may reflect particular quantities of the first and second fuels to be delivered, or may reflect particular durations in which the first fuel admission valve 159 and the second fuel admission valve 169 are active. In other embodiments, a plurality of fuel substitution maps 254 can be included for different ratios of the first fuel and second fuel.

In another adjustment step 250, the substitution fueling command 252 can be adjusted to account for deterioration or wear in the first fuel delivery system 152 indicated by the first fuel quantity error 226. The substitution fueling command 252 may include a first fueling subcommand 256 and a second fueling subcommand 258 that reflect the relative quantities of the first fuel and the second fuel to be delivered to the combustion chamber 104 for combustion during fuel substitution mode. The first fueling subcommand 256 and a second fueling subcommand 258 may be expressed quantitatively, e.g., cubic millimeters (mm³), or temporally, e.g., microseconds (μs), and may be embodied as electronic command signals communicated to the first fuel admission valve 159 and the second fuel admission valve 169 respectively. The fuel control system 170 may conduct another updating step 259 in which the fuel substitution map 254 is updated to reflect the first fuel quantity error 226. In particular, the updating step 259 can update the first fueling subcommand 256 component of the substitution fueling command 252 to adjust operation of the first fuel admission valve 159 so that desired quantities of the first fuel are delivered during fuel substitution mode and the total engine power output remains consistent.

In an embodiment, the fuel control system 170 can also utilize the first fuel quantity error 226 to assess fitness or physical condition of various components of the first fuel delivery system 152. For example, in an error comparison step 260, the first fuel quantity error 226 may be compared with a fuel component error threshold 262 that may represent the least tolerant deviation from design specifications for a particular component of the first fuel delivery system 152, for example, the first fuel admission valve 159 which may be an injector. The deviation may result from deterioration of the component over its operational lifetime and the fuel component error threshold 262 may correspond to the end of the design life for the component. If the first fuel quantity error 226 exceeds the fuel component error threshold 262, an operator or mechanic may undertake a repair step 264 to repair or replace the relevant fuel component. The need for replacement or repair of an injector or other fueling component can be communicated to an operator via an alarm or warning light, or may be transmitted to an off-machine management system. If however the first fuel quantity error 226 is within the fuel component error threshold 262, the fuel control system 170 may continue to make adjustment to the first fueling command or the substitution fueling command as needed to maintain consistent operation of the internal combustion engine in single fuel and duel fuel modes.

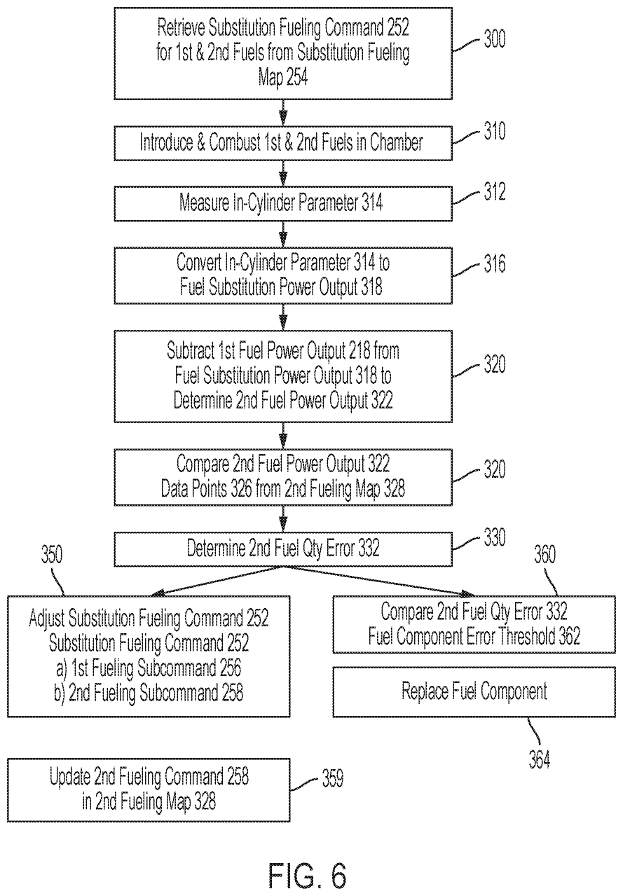

Referring to FIG. 6, there is illustrated a flowchart representing an embodiment of another algorithm by which the fuel control system 170 can utilize the first fuel quantity error 226 to analyze and correct operation of the second fuel delivery system 160 when the dual fuel system 150 operates in a fuel substitution mode combusting the first fuel, e.g., diesel, and the second fuel, e.g., natural gas. In a second command retrieval step 300, the fuel control system 170 can receive a substitution fueling command 252 from a fuel substitution map 254 that directs determined quantities of the first fuel and the second fuel to the combustion chamber 104. In the present embodiment, the substitution fueling command 252 and the fuel substitution map 254 can be the same as described with respect to FIG. 4. The substitution fueling command 252 can again be expressed quantitatively in cubic millimeters (mm³) or as the duration in which the first fuel admission valve 159 and the second fuel admission valve 169 are actively delivering the first and second fuel to the cylinder 110, and may be temporally dimensioned in microseconds (μs). In a subsequent second combustion step 310, the first and second fuels are simultaneously combusted in the combustion chamber 104, and in a second measurement step 312, the in-cylinder parameter sensor 174 can measure a second in-cylinder parameter 314, which may be the same or different from the first in-cylinder parameter 214, for example, IMEP. In a second conversion step 316, the fuel control system 170 converts the second in-cylinder parameter 314 to a fuel substitution power output 318 indicative of the engine power output for the relevant combustion chamber 104 during the engine cycle. The fuel substitution power output 318 is therefore the combined power produced by combustion of the first fuel and second fuel.

The fuel control system 170 can utilize the first fuel power output 218 and the fuel substitution power output 318 to determine the relative contribution of combusting the second fuel to the total engine power output, which may be otherwise difficult to determine in advance because of variation in the ignition stability or heat value of the second fuel. In a calculation step 320, the first fuel power output 218 is subtracted from the fuel substitution power output 318 to determine the second fuel power output 322 representing the actual power output attributable to the second fuel. In a subsequent second power comparison step 324, the fuel control system 170 may compare the second fuel power output 322 with data points 326 from a second fueling map 328 that may be indicative of the anticipated power output contribution of the second fuel, which may have been determined theoretically or empirically in advance. In a subsequent second determination step 330, the results of the second power comparison step 324 can be used to determine a second fuel quantity error 332.

In an embodiment, the second fuel quantity error 332 may be represented as a dimensionless scaler and may be used to adjust the substitution fueling command or to assess the operational fitness of the components of the second fuel delivery system 160. For example, the second fuel quantity error 332 may have a nominal value of zero (0.0) for an as-manufactured second fuel admission valve 169 operating per specification. If the second fuel admission valve 169 starts throttling flow, i.e. delivering less of the second fuel to the combustion chamber 104 than commanded, the second fuel quantity error 332 may shift to one (1.0) indicating that the commanded quantity of the second fuel should be increased. Conversely, if the second fuel admission valve 169 leaks and admits more of the second fuel than desired, the second fuel quantity error 332 may shift to minus one (−1.0) indicating that a lesser amount of the second fuel should be commanded by the fuel control system 170. The dimensionless scalar can be readily converted to adjust operation of the second fuel admission valve 169 in quantitative terms (mm³) or timing terms (μs).

As described above, the fuel control system 170 may use the second fuel quantity error 332 in a second adjustment step 350 to adjust the quantity of the second fuel delivered in accordance with the substitution fueling command 252 during fuel substitution to adjust for inefficiencies or deterioration of the second fuel admission valve 169. In a second updating step 359, the fuel control system 170 can also update the second fueling map 328 to adjust for the second fuel quantity error 332. Likewise, in another comparison step 360, the fuel control system 170 may compare the second fuel quantity error 332 with a predetermined fuel component error threshold 362 associated with a component of the second fuel delivery system 160 such as the second fuel admission valve 169 and, if appropriate, in a subsequent repair step 364, the fuel component may be repaired or replaced. The need for replacement or repair of a fuel admission valve or other fueling component can be communicated to an operator via an alarm or warning light, or may be transmitted to an off-machine management system. If however the second fuel quantity error 332 is within the fuel component error threshold 362, the fuel control system 170 may continue to make adjustment to the first fueling command or the substitution fueling command as needed to maintain consistent operation of the internal combustion engine in single fuel and duel fuel modes.

Although the fuel control system 170 has been explained with respect to a single combustion chamber 104, it will be appreciated that in embodiments where the internal combustion engine 100 includes multiple cylinders, the fuel control system can be utilized with all combustion chambers. The measurements made of the in-cylinder parameter and the subsequent processing and analysis of that data can occur dynamically so that adjustments made to the first fueling command and/or substitution fueling commands occur in real time. Accordingly, the power output and overall operation of internal combustion engine is consistent despite deterioration of the fuel delivery components or changes in fuel quality or characteristics.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An internal combustion engine comprising:
a combustion chamber including a cylinder having a piston reciprocally disposed therein;
a first fuel delivery system communicating with the combustion chamber to deliver a first fuel to the combustion chamber;
a second fuel delivery system communicating with the combustion chamber to deliver a second fuel to the combustion chamber;
an in-cylinder parameter sensor in communication with the combustion chamber to measure an in-cylinder parameter; and
an electronic controller in electronic communication with the first fuel delivery system, the second fuel delivery system, and the in-cylinder parameter sensor; the electronic controller configured to:
(i) retrieve and apply a first fueling command directing the first fuel system to deliver an initial quantity of the first fuel to the combustion chamber;
(ii) receive electronic signals from the in-cylinder parameter sensor indicative of the in-cylinder parameter as measured during combustion of only the first fuel in the combustion chamber;
(iii) convert the in-cylinder parameter to a first fuel power output indicative of power output from combustion of the initial quantity of the first fuel; and
(iv) determine a first fuel quantity error based on the first fuel power output and an anticipated first fuel power output; and
(v) adjust a substitution fueling command directing the first fuel delivery system and the second fuel delivery system to deliver a substitution quantity of the first fuel and of the second fuel to the combustion chamber.

2. The internal combustion engine of claim 1, wherein the in-cylinder parameter sensor is an in-cylinder pressure sensor and the in-cylinder parameter is indicated mean effective pressure.

3. The internal combustion engine of claim 2, wherein the first fuel is a liquid fuel and the second fuel is a gaseous fuel.

4. The internal combustion engine of claim 3, wherein the first fuel is diesel and the second fuel is natural gas.

5. The internal combustion engine of claim 1, wherein the substitution fueling command includes a first fueling subcommand and a second fueling subcommand.

6. The internal combustion engine of claim 5, further comprising updating the first fueling subcommand in a substitution fueling map.

7. (canceled)

8. The internal combustion engine of claim 1, wherein the electronic controller is configured to compare the first fuel quantity error with a fuel component error threshold to assess physical condition of a fuel component of the first fuel delivery system.

9. The internal combustion engine of claim 1, wherein the electronic controller is further configured to:
retrieve and apply the substitution fueling command to deliver the substitution quantity of the first fuel and the second fuel to the combustion chamber;
receive electronic signals from the in-cylinder parameter sensor indicative of the in-cylinder parameter during combustion of the first fuel and the second fuel;
convert the in-cylinder parameter to a fuel substitution power output;
determine a second fuel quantity error based on the fuel substitution power output; and
adjust the substitution fueling command based on the second fuel quantity error.

10. The internal combustion engine of claim 9, wherein the controller determines a second fuel power output by subtracting the first fuel power output from the fuel substitution power output.

11. The internal combustion engine of claim 10, wherein the controller determines the second fuel quantity error by comparing the second fuel power output with an anticipated second fuel power output.

12. A method of operating an internal combustion engine comprising:
commanding a first fueling command indicative of an initial quantity of a first fuel to be delivered to a combustion chamber of an internal combustion engine during a single fuel mode;
delivering and combusting the first fuel in the combustion chamber;
measuring an in-cylinder parameter during combustion of only the first fuel in the combustion chamber;
converting the in-cylinder parameter to a first fuel power output indicative of power output from combustion of the first fuel;
determining a first fuel quantity error based on the first fuel power output and an anticipated first fuel power output;
adjusting a substitution fueling command based on the first fuel quantity error, the substitution fueling command directing a substitution quantity of the first fuel and a second fuel to be delivered to the combustion chamber during a fuel substitution mode.

13. The method of claim 12, further comprising:
measuring the in-cylinder parameter during combustion of the first fuel and the second fuel in the combustion chamber;
converting the in-cylinder parameter to a fuel substitution power output;
determining a second fuel power output by subtracting the first fuel power output from the fuel substitution power output;
determining a second fuel quantity error based on the second fuel power output; and
adjusting the substitution fueling command based on the second fuel quantity error.

14. The method of claim 12, wherein the substitution fueling command includes a first fueling subcommand indicative of a first fuel substitution quantity and a second fueling subcommand indicative of a second fuel substitution quantity.

15. The method of claim 14, further comprising updating the first fueling subcommand in a substitution fueling map.

16. (canceled)

17. The method of claim 12, further comprising comparing the first fuel quantity error with a fuel component error threshold to assess physical condition of a fuel component of a first fuel delivery system communicating with the combustion chamber for delivering the first fuel.

18. A fuel control system for controlling operation of an internal combustion engine comprising:
an in-cylinder parameter sensor in communication with a combustion chamber of an internal combustion engine to measure an in-cylinder parameter;
an electronic controller in communication with the in-cylinder parameter sensor, a first fuel delivery system, and a second fuel delivery system, the electronic controller configured to:
(i) retrieve and apply a first fueling command directing the first fuel system to deliver an initial quantity of a first fuel to the combustion chamber;
(ii) receive electronic signals from the in-cylinder parameter sensor indicative of the in-cylinder parameter as measured during combustion of the first fuel;
(iii) convert the in-cylinder parameter to a first fuel power output;
(iv) determine a first fuel quantity error based on the first fuel power output and an anticipated first fuel power output retrieved; and
(v) adjust the first fueling command based on the first fuel quantity error.

19. The fuel control system of claim 18, wherein the electronic controller is further configured to:
retrieve and apply a substitution fueling command to deliver a substitution quantity of the first fuel and second fuel to the combustion chamber;
receive electronic signals from the in-cylinder parameter sensor indicative of the in-cylinder parameter during combustion of the first fuel and the second fuel;
convert the in-cylinder parameter to a fuel substitution power output;
determine a second fuel power output based on the fuel substitution power output;
determine a second fuel quantity error based on the second fuel power output; and
adjust the substitution fueling command based on the second fuel quantity error.

20. The fuel control system of claim 19, wherein the in-cylinder parameter sensor is an in-cylinder pressure sensor and the in-cylinder parameter is indicated mean effective pressure.

21. The internal combustion engine of claim 1, wherein the electronic controller retrieves the anticipated first fuel power output from a first fueling map directing an initial quantity of the first fuel to the combustion chamber.
